(19) United States
(12) Patent Application Publication
(10) Pub. No.: US 2024/0092996 A1
(43) Pub. Date: Mar. 21, 2024

(54) RUBBER COMPOSITION FOR TIRE TREADS AND PNEUMATIC TIRE

(71) Applicant: Toyo Tire Corporation, Itami-shi (JP)

(72) Inventors: Hama Nagai, Itami-shi (JP); Norio Minouchi, Itami-shi (JP)

(73) Assignee: Toyo Tire Corporation, Itami-shi (JP)

(21) Appl. No.: 18/234,507

(22) Filed: Aug. 16, 2023

(30) Foreign Application Priority Data
Sep. 21, 2022 (JP) 2022-150122

(51) Int. Cl. C08K 3/22; B60C 1/00

(52) U.S. Cl. CPC C08K 3/22; B60C 1/0016; C08K 2003/2296

(57) ABSTRACT

A rubber composition for tire treads comprising zinc oxide wherein the zinc oxide contains aluminum and iron. It is preferred that the zinc oxide has a content of the iron of 15 ppm or more and 100 ppm or less and a content of the aluminum of 40 ppm or more and 100 ppm or less. It is more preferred that the zinc oxide has a ratio of a content of the iron to a content of the aluminum of 0.2 to 2.3. It is more preferred that the zinc oxide has a content of the iron of 15 ppm or more and 80 ppm or less.

### BACKGROUND OF THE INVENTION

### Field of the Invention

The present invention relates to a rubber composition for tire treads and a pneumatic tire.

### Description of the Related Art

A pneumatic tire is used for a long time period, and therefore a rubber material constituting a tread part of a pneumatic tire (hereinafter also referred to as “tread rubber”) is required to have abrasion resistance from the viewpoint of improving durability. The abrasion resistance of a tread part is generally improved by optimizing various compounding agents added to a rubber composition as a raw material.

Patent Document 1 mentioned below describes that a zinc oxide powder is synthesized by a method in which an aqueous solution containing a zinc salt is neutralized to obtain a precipitate such as a hydroxide and the precipitate is heated after filtration and drying (also referred to as “American process” or “wet process”) as zinc oxide for use as a raw material of a rubber composition.

### PRIOR ART DOCUMENT

### Patent Document

Patent Document 1: JP-A-2000-95519

### SUMMARY OF THE INVENTION

Patent Document 1 mentioned above is characterized by producing zinc oxide by a wet process, and there is no description about the properties of the zinc oxide.

The present inventors have focused on the metallic composition of zinc oxide to be added to a rubber composition as a raw material to improve the abrasion resistance of a tread rubber, and as a result have found that when zinc oxide having a specific metallic composition is added to a rubber composition, a vulcanized rubber of the rubber composition has significantly improved abrasion resistance.

In view of the above circumstances, it is an object of the present invention to provide a rubber composition for tire treads as a raw material of a vulcanized rubber having improved abrasion resistance and a pneumatic tire containing a vulcanized rubber of the rubber composition for tire treads.

The above object can be achieved by the following configurations. Specifically, the present invention relates to a rubber composition for tire treads (1) containing zinc oxide, wherein the zinc oxide contains aluminum and iron.

The rubber composition for tire treads (1) is preferably a rubber composition for tire treads (2), wherein the zinc oxide has a content of the iron of 15 ppm or more and 100 ppm or less and a content of the aluminum of 40 ppm or more and 100 ppm or less.

The rubber composition for tire treads (1) or (2) is preferably a rubber composition for tire treads (3), wherein the zinc oxide has a ratio of a content of the iron to a content of the aluminum of 0.2 to 2.3.

Any one of the rubber compositions for tire treads (1) to (3) is preferably a rubber composition for tire treads (4), wherein the zinc oxide has a content of the iron of 15 ppm or more and 80 ppm or less.

The present invention also relates to a pneumatic tire containing a vulcanized rubber of any one of the rubber compositions for tire treads (1) to (4).

As far as the present inventors are aware, there is no technique in which the composition of metals contained in zinc oxide is examined in detail. Under the circumstances, the present inventors have intensively studied, and as a result have found that when zinc oxide having a specific metallic composition, specifically zinc oxide containing aluminum and iron is added to a rubber composition for tire treads, a vulcanized rubber of the rubber composition has improved abrasion resistance. Particularly, the present inventors have found that when zinc oxide whose iron content is 15 ppm or more and 100 ppm or less and whose aluminum content is 40 ppm or more and 100 ppm or less or zinc oxide whose ratio of an iron content to an aluminum content is 0.2 to 2.3 is added to a rubber composition, a vulcanized rubber of the rubber composition has further improved abrasion resistance.

It should be noted that a pneumatic tire is used for a long time period, and therefore a tread rubber is required to have not only abrasion resistance just after production (hereinafter simply referred to as “abrasion resistance”) but also abrasion resistance after a lapse of long time from production (abrasion resistance after an aging test corresponding to such abrasion resistance is also referred to as “abrasion resistance after aging”). In the present invention, the zinc oxide whose iron content is 15 ppm or more and 80 ppm or less is particularly preferably added to a rubber composition for tire treads, which allows a vulcanized rubber (tread rubber) of the rubber composition to have not only improved abrasion resistance just after production but also improved abrasion resistance after aging.

A vulcanized rubber of the rubber composition for tire treads containing zinc oxide according to the present invention is excellent in abrasion resistance. Therefore, a pneumatic tire containing such a vulcanized rubber (tread rubber) of the rubber composition for tire treads is excellent in durability because the tread part thereof is excellent in abrasion resistance.

### DETAILED DESCRIPTION OF THE PREFERRED EMBODIMENTS

A rubber composition for tire treads according to the present invention contains zinc oxide, wherein the zinc oxide contains aluminum and iron. The zinc oxide is preferably powdery zinc oxide (zinc oxide powder), and the specific surface area of the zinc oxide powder is preferably 2 to 10 [m²/g], more preferably 2 to 6 [m²/g]. The specific surface area of the zinc oxide powder according to the present invention can be measured by, for example, the BET method (JIS R1626).

As described above, the American process (wet process) is known as a method for producing zinc oxide. However, as a method other than that, the French process is known. The French process is a method in which metallic zinc is evaporated by heating and zinc vapor is oxidized to obtain a zinc oxide powder. A metallic zinc source as a raw material can be selected from various options such as distilled zinc, electrolytic zinc, and recycle zinc, and examples of recycle zinc include zinc dross, oxidized ash, and electric furnace dust. The zinc oxide used in the present invention is preferably a zinc oxide powder obtained by the French process in which zinc dross is evaporated by heating and zinc vapor is oxidized.

The zinc oxide used in the present invention contains aluminum and iron. In the present invention, the zinc oxide is particularly preferably zinc oxide (i) whose iron content is 15 ppm or more and 100 ppm or less and whose aluminum content is 40 ppm or more and 100 ppm or less or zinc oxide (ii) whose ratio of an iron content to an aluminum content is 0.2 to 2.3 because when such zinc oxide is added to a rubber composition, a vulcanized rubber of the rubber composition has more excellent abrasion resistance. The reason why a vulcanized rubber of a rubber composition containing the zinc oxide (i) or (ii), particularly the zinc oxide (ii) is excellent in abrasion resistance is not clear, but it is expected that when trace amounts of aluminum and iron are present in a vulcanized rubber, crosslinking form in the vulcanized rubber changes from usual crosslinking form so that the abrasion resistance of the vulcanized rubber improves.

Further, in the present invention, the zinc oxide is particularly preferably zinc oxide (iii) whose iron content is 15 ppm or more and 80 ppm or less because when such zinc oxide is added to a rubber composition, a vulcanized rubber of the rubber composition is excellent not only in abrasion resistance (abrasion resistance just after production) but also in abrasion resistance after aging. The reason why a vulcanized rubber of a rubber composition containing the zinc oxide (iii) is significantly excellent in abrasion resistance after aging is not clear, but it is expected that when the zinc oxide is designed to have an iron content of 15 ppm or more and 80 ppm or less, the influence of oxidation degradation of iron is prevented while crosslinking form in the vulcanized rubber changes from usual crosslinking form so that the abrasion resistance after aging can be maintained and improved.

The amount of the zinc oxide contained in the rubber composition for tire treads according to the present invention is preferably 0.5 to 10 parts by mass, more preferably 1 to 5 parts by mass per 100 parts by mass of the total amount of a rubber component.

The rubber composition for tire treads according to the present invention contains a rubber component. As the rubber component, for example, a diene-based rubber is preferred. Examples of the diene-based rubber include, but are not limited to, natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These butadiene-based rubbers may be used singly or in combination of two or more of them.

The rubber composition for tire treads according to the present invention may contain carbon black and/or silica as a filler, a vulcanizing agent, a vulcanization accelerator, an antiaging agent, stearic acid, a softener such as wax or oil, a processing aid, and others.

As the reinforcing filler, carbon black and/or silica are/is preferably used. That is, the reinforcing filler may be carbon black alone, silica alone, or a combination of carbon black and silica. It is preferred that carbon black is used alone or carbon black and silica are used in combination. The content of the reinforcing filler is not limited and is, for example, preferably 10 to 140 parts by mass, more preferably 20 to 100 parts by mass, even more preferably 30 to 80 parts by mass per 100 parts by mass of the total amount of a rubber component.

Examples of the carbon black that can be used include: carbon blacks usually used in the rubber industry, such as SAF, ISAF, HAF, FEF, and GPF; and conductive carbon blacks such as acetylene black and ketjen black. Examples of the silica to be used include silicas usually used for rubber reinforcement, such as wet silica, dry silica, sol-gel silica, and surface-treated silica. Among them, wet silica is preferred.

When silica is contained as a filler, a silane coupling agent is also preferably contained. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

As the vulcanizing agent, sulfur can suitably be used. The sulfur may be ordinary sulfur for rubber, and sulfur such as powdered sulfur, precipitated sulfur, insoluble sulfur, and highly dispersible sulfur can be used. The content of the vulcanizing agent in the rubber composition for tire treads according to the present invention is preferably 0.5 to 5 parts by mass per 100 parts by mass of the total amount of a rubber component.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The rubber composition for tire treads according to the present invention is obtained by kneading not only the zinc oxide, the rubber component, the filler, the vulcanizing agent, and the vulcanization accelerator but also the antiaging agent, stearic acid, the softener such as wax or oil, the processing aid, and others using a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

A vulcanized rubber of the rubber composition for tire treads according to the present invention is excellent in abrasion resistance. Therefore, the rubber composition for tire treads according to the present invention can suitably be used for a tread part constituting a pneumatic tire.

### EXAMPLES

The present invention will more specifically be described below with reference to examples.

### (Preparation of Zinc Oxides 1 to 4)

Zinc dross was heated at 950° C. to generate zinc vapor, and the zinc vapor was oxidized and burned by blowing air thereinto to generate zinc oxide. The generated zinc oxide was cooled and then collected to obtain a zinc oxide powder. On the other hand, as zinc oxide 1, a commercially-available product (“Zinc oxide grade 2” manufactured by MITSUI MINING & SMELTING CO., LTD.) was used. The contents of iron (Fe) and aluminum (Al) in each of the zinc oxides 1 to 4 were measured by inductively coupled plasma optical emission spectrometry (ICP-OES) using “Optima 8300” manufactured by PerkinElmer. The results are shown in Table 1. It should be noted that “N.D” shown in Table 1 means that the content is below the detection limit.

TABLE 1

| | Zinc oxide 1 | Zinc oxide 2 | Zinc oxide 3 | Zinc oxide 4 |
|---|---|---|---|---|
| Fe (ppm) | N.D | 24.72 | 61.14 | 88.38 |
| Al (ppm) | 0.60 | 47.36 | 82.01 | 96.17 |
| Fe/Al ratio | 0.00 | 0.52 | 0.75 | 0.92 |

### (Preparation of Rubber Compositions for Tire Treads)

A rubber composition of each of Examples 1 to 6 and Comparative Examples 1 and 2 was prepared by blending compounding agents with 100 parts by mass of a rubber component in accordance with the formulation shown in Tables 2 and 3 and kneading the resultant using an ordinary Banbury mixer. The compounding agents shown in Tables 2 and 3 are as follows.
Natural rubber (NR): RSS #3
Butadiene rubber (BR): trade name “BR150B”, manufactured by UBE Corporation
Styrene-butadiene rubber (SBR): trade name “HPR350”, manufactured by JSR Corporation
Carbon black 1: trade name “Seast 6”, manufactured by TOKAI CARBON CO., LTD.
Carbon black 2: trade name “Seast 3”, manufactured by TOKAI CARBON CO., LTD.
Silica: trade name “Nipsil AQ”, manufactured by TOSOH SILICA CORPORATION
Silane coupling agent: trade name “Si69”, manufactured by Evonik Industries AG
Stearic acid: trade name “Beads Stearic Acid”, manufactured by NOF CORPORATION
Wax: trade name “OZOACE0355”, manufactured by NIPPON SEIRO CO., LTD.
Antiaging agent: trade name: “Antigen 6C”, manufactured by SUMITOMO CHEMICAL COMPANY, LIMITED
Oil: trade name “Process NC140”, manufactured by JXTG Energy Corporation
Sulfur: trade name “Powder Sulfur”, manufactured by Tsurumi Chemical Industry Co., ltd.
Vulcanization accelerator 1: trade name “SOXINOL CZ”, manufactured by SUMITOMO CHEMICAL COMPANY, LIMITED
Vulcanization accelerator 2: trade name “NOCCELER DZ-G”, manufactured by OUCHI SHINKO CHEMICAL INDUSTRIAL CO., LTD.

Each of the rubber compositions of Examples 1 to 6 and Comparative Examples 1 and 2 obtained above having a predetermined shape was vulcanized at 160° C. for 30 minutes to measure abrasion resistance and abrasion resistance after aging.

### (Abrasion Resistance)

Abrasion loss was measured in accordance with JIS K6264 using a Lambourn abrasion tester manufactured by Iwamoto Seisakusho Co., Ltd. under conditions of a load of 40 N and a slip ratio of 30%. In the case of Examples 1 to 3, abrasion resistance was expressed as an index number determined by taking the reciprocal of the abrasion loss of Comparative Example 1 as 100, and in the case of Examples 4 to 6, abrasion resistance was expressed as an index number determined by taking the reciprocal of the abrasion loss of Comparative Example 2 as 100. The larger index number indicates that abrasion resistance is more excellent. The results are shown in Tables 2 and 3.

(Abrasion Resistance after Aging)

Aging was performed using “Gear oven” manufactured by Toyo Seiki Seisaku-sho, Ltd. at 90° C. for 48 hours. As in the case of abrasion resistance, abrasion resistance of the sample after aging was determined by measuring abrasion loss in accordance with JIS K6264 using a Lambourn abrasion tester manufactured by Iwamoto Seisakusho Co., Ltd. under conditions of a load of 40 N and a slip ratio of 30%. In the case of Examples 1 to 3, abrasion resistance after aging was expressed as an index number determined by taking the reciprocal of the abrasion loss of Comparative Example 1 as 100, and in the case of Examples 4 to 6, abrasion resistance after aging was expressed as an index number determined by taking the reciprocal of the abrasion loss of Comparative Example 2 as 100. The larger index number indicates that abrasion resistance is more excellent. The results are shown in Tables 2 and 3.

TABLE 2

| | Comparative | | | |
|---|---|---|---|---|
| | Example 1 | Example 1 | Example 2 | Example 3 |
| NR | 70 | 70 | 70 | 70 |
| BR | 30 | 30 | 30 | 30 |
| Carbon black 1 | 40 | 40 | 40 | 40 |
| Zinc oxide 1 | 3 | | | |
| Zinc oxide 2 | | 3 | | |
| Zinc oxide 3 | | | 3 | |
| Zinc oxide 4 | | | | 3 |
| Stearic acid | 2 | 2 | 2 | 2 |
| Antiaging agent | 1 | 1 | 1 | 1 |
| Sulfur | 2 | 2 | 2 | 2 |
| Vulcanization | 1.5 | 1.5 | 1.5 | 1.5 |
| accelerator 1 | | | | |
| Abrasion resistance | 100 | 106 | 105 | 106 |
| Abrasion resistance | 100 | 107 | 105 | 94 |
| after aging | | | | |

TABLE 3

| | Comparative | | | |
|---|---|---|---|---|
| | Example 2 | Example 4 | Example 5 | Example 6 |
| NR | 30 | 30 | 30 | 30 |
| SSBR | 70 | 70 | 70 | 70 |
| Carbon black 2 | 5 | 5 | 5 | 5 |
| Silica | 90 | 90 | 90 | 90 |
| Silane coupling agent | 9 | 9 | 9 | 9 |
| Zinc oxide 1 | 2 | | | |
| Zinc oxide 2 | | 2 | | |
| Zinc oxide 3 | | | 2 | |
| Zinc oxide 4 | | | | 2 |
| Stearic acid | 2 | 2 | 2 | 2 |
| Wax | 2 | 2 | 2 | 2 |
| Antiaging agent | 2 | 2 | 2 | 2 |
| Oil | 20 | 20 | 20 | 20 |
| Sulfur | 2 | 2 | 2 | 2 |
| Vulcanization | 1.5 | 1.5 | 1.5 | 1.5 |
| accelerator 1 | | | | |
| Vulcanization | 1.5 | 1.5 | 1.5 | 1.5 |
| accelerator 2 | | | | |
| Abrasion resistance | 100 | 108 | 107 | 107 |
| Abrasion resistance | 100 | 107 | 105 | 97 |
| after aging | | | | |

As can be seen from the results shown in Tables 2 and 3, all the vulcanized rubbers of the rubber compositions for tire treads according to Examples 1 to 6 are excellent in abrasion resistance. Particularly, it can be seen that the vulcanized rubbers of the rubber compositions for tire treads according to Examples 1 and 2 and 4 and 5 contain zinc oxide whose iron content is 15 ppm or more and 80 ppm or less, and therefore have improved not only in abrasion resistance (abrasion resistance just after production) but also in abrasion resistance after aging.

What is claimed is:

1. A rubber composition for tire treads comprising zinc oxide,
wherein the zinc oxide contains aluminum and iron.

2. The rubber composition for tire treads according to claim 1, wherein the zinc oxide has a content of the iron of 15 ppm or more and 100 ppm or less and a content of the aluminum of 40 ppm or more and 100 ppm or less.

3. The rubber composition for tire treads according to claim 1, wherein the zinc oxide has a ratio of a content of the iron to a content of the aluminum of 0.2 to 2.3.

4. The rubber composition for tire treads according to claim 1, wherein the zinc oxide has a content of the iron of 15 ppm or more and 80 ppm or less.

5. A pneumatic tire comprising a vulcanized rubber of the rubber composition for tire treads according to claim 1.
